(19) United States
(12) Patent Application Publication
(10) Pub. No.: US 2006/0231794 A1
(43) Pub. Date: Oct. 19, 2006

(54) Image display device

(76) Inventors: Yoshihiro Sakaguchi, Ibaraki (JP); Kazuhito Makino, Yokohama (JP); Hiroshi Iwasa, Hayama (JP); Kazuhiko Yoshizawa, Yokohama (JP); Hideki Yoshida, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/367,383

(22) Filed: Mar. 6, 2006

(30) Foreign Application Priority Data
Apr. 13, 2005 (JP) 2005-115235
Dec. 20, 2005 (JP) 2005-365693

(51) Int. Cl. C09K 19/34

(52) U.S. Cl. 252/299.61

(57) ABSTRACT

An image display device is arranged to irradiate a ray of light from a light source into liquid crystal display devices, form an optical image corresponding with a video signal, and expansively project the optical image. The image display device includes a reflection mirror for reflecting the ray of light irradiated onto the liquid crystal display devices, an optical sensor being located on the reflection mirror and for detecting a light intensity, a drive circuit that causes the liquid crystal display devices to be driven, and a control unit that controls the drive circuit based on the light intensity detected by the optical sensor. In operation, the image display device provides a capability of adjusting a variable reference voltage of a common electrode brought about by variation with time ascribable to the liquid crystal display devices without preventing display of an input video signal.

### BACKGROUND OF THE INVENTION

The present invention relates to an image display device which is arranged to expansively project an image appearing on display devices onto a screen for forming the expanded image on the screen.

In the display devices of the image display device, for example, the active-matrix liquid crystal display devices (often called the liquid crystal display panel), an AC voltage to be reversed in a field or a line period is applied between a pixel electrode and a common electrode. However, the characteristic variation may take place in a transistor for driving the pixel electrode, so that the DC voltage applied onto the common electrode may be shifted from the reversed center voltage. As a result, flickers take place on the liquid crystal display devices. In order to prevent those flickers, the technology of automatically adjusting a reference voltage to be applied onto the common electrode before shippment has been proposed in JP-A-6-130920.

As another technology of preventing those flickers, the technology of detecting the flickers occurring on the image projected from the liquid crystal projector onto the screen through the effect of an optical sensor located on the center of the screen and automatically adjusting the voltage of the common electrode has been proposed in JP-A-6-138842.

### SUMMARY OF THE INVENTION

The technology disclosed in JP-A-6-130920 is used in the manufacturing process and needs another operating device to be located outside. That is, the technology does not provide a self-adjustment of the product itself. Hence, this technology has difficulty in adjusting image quality degraded by variation with time of a reference voltage of the common electrode, the variation with time ascribable to the shipped liquid crystal display devices.

Further, in the technology disclosed in JP-A-6-138842, the optical sensor is located on the center of the screen. Hence, a viewer is likely to visually recognize (hereafter, simply referred to as “recognize”) the shadow of the optical sensor appearing on the image displayed on the screen.

The present invention is made in consideration of the foregoing problematic matters, and it is an object of the present invention to provide an image display device which is arranged to properly correct image quality changed by variation with time ascribable to the display devices.

According to the present invention, an optical sensor for detecting flickers is installed on a reflection mirror that serves to reflect a ray of light irradiated onto the display device installed in the image display device. Further, the optical sensor for detecting flickers may be located in a projecion lens unit. This location of the optical sensor results in being able to reduce the adverse influence caused by the projection of the shadow of the optical sensor itself and the wirings of the optical sensor on the screen.

The present invention provides the image display device which provides a capability of properly correcting image quality changed by variation with time of the image display device.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a liquid crystal display device according to a first embodiment of the present invention;

FIG. 2 is a block diagram showing a liquid crystal display device according to a second embodiment of the present invention;

FIGS. 3A and 3B are schematic block diagram showing a back mirror included in a third embodiment of the present invention;

FIG. 4 is a flowchart showing a control flow of a control circuit;

FIG. 5 is a chart showing a reverse signal to be inputted into a liquid crystal display device;

FIG. 6 is a chart showing a detection signal of the optical sensor;

FIG. 7 is a block diagram showing a signal processing circuit;

FIG. 8 is a model view showing a projection television set; and

FIG. 9 is a model view showing a projection lens included in a fourth embodiment of the present invention.

### DETAILED DESCRIPTION OF THE EMBODIMNTS

Best Modes of Carrying Out the Present Invention

Hereafter, the best modes of carrying out the present invention will be described with reference to the appended drawings. In each of those drawings, the components having the common functions have the same reference numbers, and the already described components are not described again for avoiding the duplicated description.

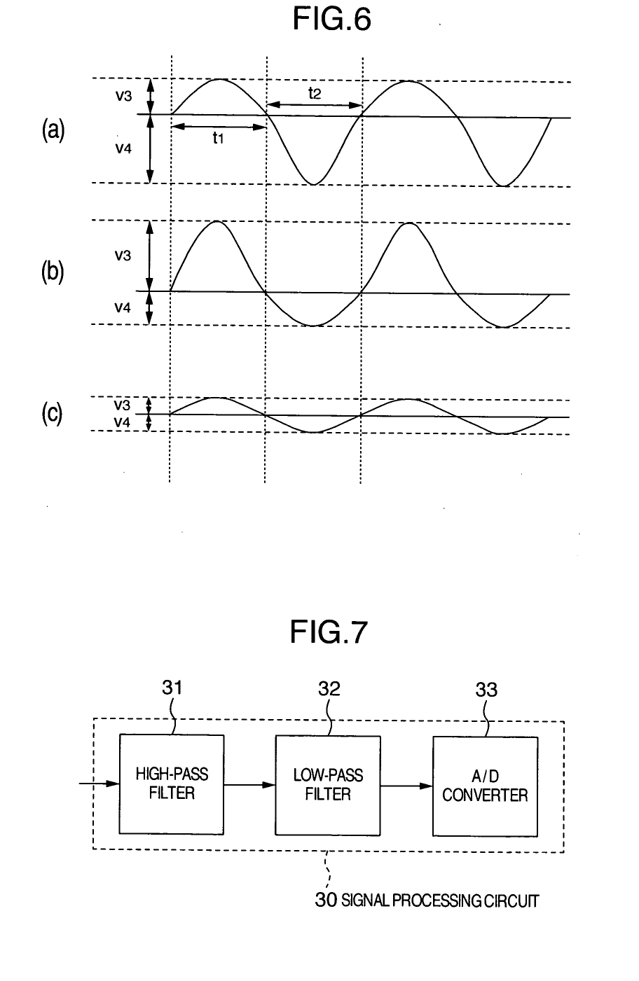

Before describing the present invention, the flickers appearing by variation of a reference voltage Vcom of a common electrode will be described with reference to FIGS. 5 and 6.

FIG. 5 is a chart showing relation between a reference voltage to be applied onto the common electrode of a liquid crystal display device and a reversed signal voltage to be applied onto a pixel-driving transistor. FIG. 6 is a model view showing an AC component of a detection signal of an optical sensor to be supplied in the case of detecting the image on the liquid crystal display device projected onto the screen through the effect of the optical sensor. Ordinarily, a display electrode of the liquid crystal display device is connected with a drain electrode of the pixel-driving transistor so that a voltage derived by subtracting a voltage loss between a drain and a source of the pixel-driving transistor from a reversed signal voltage Vs to be applied onto a source electrode of the pixel-driving transistor may be applied onto a display electrode. Hence, it is necessary to consider this voltage loss. Herein, however, for facilitating the description, the description will be expanded on the assumption that no voltage loss takes place.

In FIG. 5, flickers take place in a case that a positive reverse signal voltage (voltage difference) against the reference voltage Vcom of the common electrode (not shown) is not equal to a negative reverse signal voltage against the reference voltage Vcom thereof. V1 denotes a positive voltage (voltage difference) of the reversed signal to be applied to the pixel-driving transistor (not shown) against the reference voltage Vcom of the common electrode. V2 denotes a negative voltage (voltage difference) of the reversed signal to be applied to the pixel-driving transistor.

In the case of |V1|<|V2| (| | denoting an absolute value), the peak value of the positive reversed signal against the reference voltage Vcom is remarkably different from the peak value of the negative one against the reference voltage Vcom, so that the flickers may take place. The detection signal to be supplied from the optical sensor when the flickers take place indicates such a waveform as shown in FIG. 6A, in which the detection signal is at high level and the peak value of the positive reversed signal is remarkably different from that of the negative reverse signal.

Also in the case of |V1|>|V2|, like the case of |V1|<|V2|, the peak value of the positive reversed signal against the reference voltage Vcom is remarkably different from that of the negative reverse signal, so that the flickers may take place. The detection signal to be supplied from the optical sensor in this case indicates such a waveform as shown in FIG. 6B, in which the detection signal is at high level and the peak value of the positive reversed signal is remarkably different from that of the negative reverse signal.

However, in the case of |V1|=|V2|, the peak value of the positive reversed signal against the reference voltage Vcom is equal to that of the negative reversed signal, so that no flicker may take place. The detection signal to be supplied from the optical sensor (not shown) indicates such a waveform as shown in FIG. 6C, in which the detection signal is at low level and the peak value of the positive reversed signal is equal to that of the negative reversed signal.

That is, if a voltage (voltage difference) between an upper peak and a lower peak of the detection signal waveform shown in FIG. 6C is equal to or less than a predetermined voltage, no viewer can recognize the flickers. Hereafter, an upper limit voltage of the voltage (voltage difference) between the upper peak and the lower peak in which voltage no viewer can recognize the flickers is referred to as a flicker limit voltage, which is denoted by V_{FL}. This voltage value is variable in the projection optical system or the optical sensor. However, it is substantially same among the display devices of the same type. This flicker limit voltage V_{FL} can be measured and determined by a predetermined measuring pattern in advance. Hence, in a case that the flickers are brought about by variation of the reference voltage Vcom of the common electrode caused by variation with time, the detection signal voltage is measured by using the same measuring pattern, and the reference voltage Vcom of the common electrode is changed in the predetermined direction in a predetermined step (for example, in the case of FIG. 6A, it is changed in the direction of reducing V4, that is, lowering the reference voltage Vcom) so that the voltage (voltage difference) Vₚₚ between the upper peak and the lower peak of the detection signal voltage may be made equal to or less than the flicker limit voltage V_{FL}. This change makes it possible to adjust the variable reference voltage of the common electrode caused by the variation with time ascribable to the liquid crystal display device into the excellent reference voltage (that is, the voltage where no flicker can be recognized). Hereafter, this adjustment may be referred to as “flicker adjustment”.

Hereafter, the embodiments of the present invention arranged to use the foregoing flicker adjustment will be described in detail.

First Embodiment

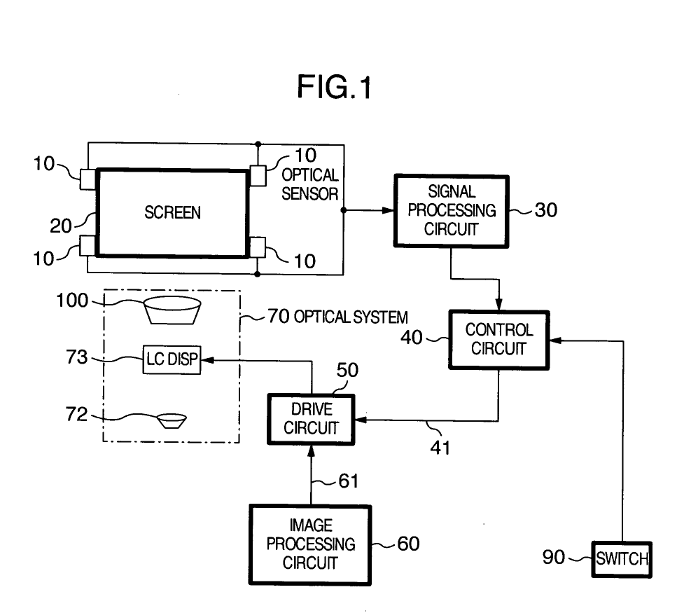

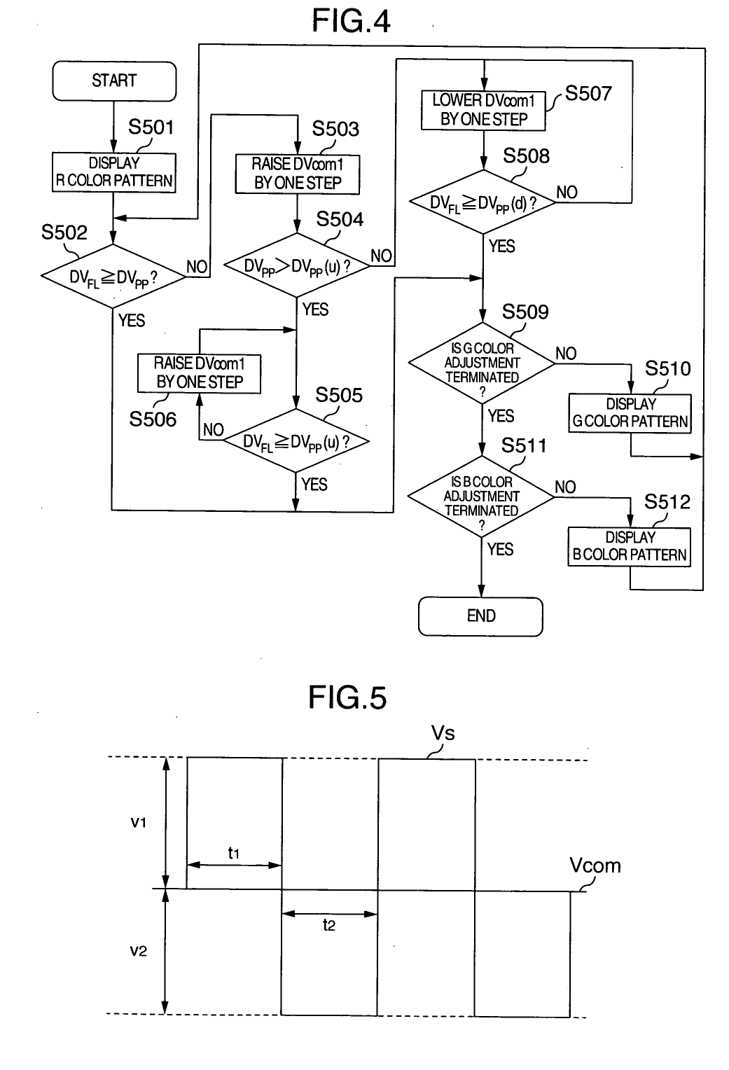

FIG. 1 is a block diagram showing a liquid crystal display device according to the first embodiment of the present invention. FIG. 4 shows a control flow of a control circuit included in the first embodiment. FIG. 7 is a block diagram showing a signal processing circuit included in the first embodiment.

In FIG. 1, the liquid crystal display device is arranged to have an image processing circuit 60, a drive circuit 50, an optical system 70, optical sensors 10, a signal processing circuit 30, a control circuit 40, and a switch 90. The image processing circuit 60 performs a predetermined image processing operation with respect to a video signal (not shown). The drive circuit 50 operates to drive a liquid crystal display device 73 based on the video signal 61 sent from the image processing circuit and a test pattern used for adjustment of flickers stored in an internal memory (not shown). The optical system 70 includes a light source 72, a liquid crystal display device 73 and a projection lens 100. In the optical system 70, the liquid crystal display device 70 modulates a light intensity of a ray of light from the light source in accordance with a drive signal sent from the drive circuit 50. Then, the formed optical image (not shown) is expanded through the projection lens 100 and then is projected onto a screen. The optical sensors 10 are located on the outer peripheral portion (for example, outside of the effective display area of the screen 20) of the screen and are served to detect an image ray of light projected closer to the outer peripheral portion of the screen. The signal processing circuit 30 operates to process signals sent from the optical sensors 10. The control circuit 40 outputs predetermined control information 41 in accordance with the input signal sent from the signal processing circuit. The switch 90 operates to indicate the start of adjusting flickers to the control circuit 40.

The drive circuit 50 has a function of supplying a reference voltage Vcom to be applied onto the common electrode (not shown) of the liquid crystal display device 73 and a reversed signal to be applied onto the pixel-driving transistor (not shown) and forming the corresponding optical image with the video signal on the liquid crystal display device 73. Moreover, the drive circuit 50 has a memory (not shown) built therein that pre-stores the test patterns used for adjusting flickers, that is, raster patterns. The drive circuit 50 operates to display the raster pattern used for adjusting the flickers of a specified color (for example, one of R, G and B colors) at a specified display location (that is, the installed location of the optical sensor 10) on the liquid crystal display device 73 in accordance with the control information 41 sent from the control circuit 40. Further, the drive circuit 50 provides a reference voltage generator circuit (not shown) for generating the reference voltage Vcom to be applied onto the common electrode of the liquid crystal device 73. The reference voltage generator circuit (not shown) is arranged to generate the corresponding reference voltage Vcom with the digital value (the digital reference voltage DVcom) contained in the control information 41 to be inputted from the outside (herein, the control circuit 40). If the liquid crystal display device has a three-plate composition, the reference voltage generator circuit (not shown) is provided for each color. Hereafter, the reference voltage generator circuit is not described in more detail.

The control circuit 40 is composed of a microcomputer served as means for controlling an operation. The control circuit 40 controls adjustment of flickers according to a program built in a PROM (not shown). This nonvolatile memory (not shown) stores control information required for adjusting flickers including display location information (not shown) provided when displaying the raster pattern, color specifying information for specifying a color (for example, one of R, G and B) of the raster pattern, a digital flicker limit voltage DV_{FL} (not shown) corresponding with the flicker limit voltage V_{FL}, a digital reference voltage DVcom (not shown) corresponding with the reference voltage Vcom to be applied to the current set common electrode, and a digital voltage step DVstep (not shown) used for changing the reference voltage at a predetermined voltage step. This memory stores a value set when adjusting the flickers in shipping or at the previous adjustment of the flickers as the reference voltage Vcom to be applied onto the current set common electrode. If the liquid crystal display has a three-plate composition, the digital reference voltage DVcom is stored for each of R, G and B colors.

Further, the number of the optical sensors 10 located on the outer periphery of the screen is determined on the quantity of light received by the optical sensors. If the quantity of light irradiated onto one optical sensor is small, the amplitude of the signal to be outputted from the optical sensor becomes small, so that the excellent adjustment is made difficult. In this case, therefore, a plurality of optical sensors are provided. The provision of plural optical sensors results in integrating the signals sent from the optical sensors, making the amplitudes of the output signals, and thereby improving the adjustment accuracy. Moreover, for improving the adjustment accuracy, in addition to the increase of the optical sensors in number, it is possible to take the method of making the time taken in applying a ray of light onto the optical sensors longer.

In the liquid crystal display device shown in FIG. 1, ordinarily, the image processing circuit 60 performs a predetermined signal processing with respect to the input video signal (not shown). The processed signal is formed as an optical image on the liquid crystal display device 73 through the drive circuit 50. Then, the optical image is expansively projected onto the screen 20 through the optical system 70, for displaying the image corresponding with the input video signal.

While the image is being displayed at a normal mode, for example, by operating the switch 90 (not limited to this), the liquid crystal display device starts adjustment of flickers. That is, the optical image of the test pattern stored in the drive circuit 50, that is, the raster pattern is displayed on the liquid crystal display device 73 by the drive circuit 50, and the raster pattern image is projected onto the screen 20 through the optical system 70. Then, by detecting the image light of the raster pattern projected onto the screen 20 through the optical sensors 10, the flickers of the liquid crystal display device 73 are measured, and the control circuit 40 automatically adjusts the reference voltage Vcom to be applied onto the common electrode of the liquid crystal display device 73 from the current set value to the value of the excellent state with no flickers recognized (that is, where the detection signal voltage Vₚₚ is equal to or less than the flicker limit voltage V_{FL}) according to the detection signals measured by the optical sensors.

Hereafter, the details of adjustment of flickers will be described along the control flow shown in FIG. 4 with reference to FIGS. 1 and 7.

When the control circuit 40 detects that the switch 90 is operated, the control circuit 40 starts to adjust the flickers. In a step 501 (hereafter, the word “step” being often abbreviated simply as “S”), the control circuit 40 selects information for specifying a first color (for example, the R color) of the raster pattern from the memory (not shown) and then sends out the selected information as the control information 41 to the drive circuit 50. Based on the raster pattern stored in the built-in memory, the drive circuit 50 generates the raster pattern corresponding with the color specifying information and forms an optical image of the raster pattern of the specified color by driving the liquid crystal display device 73. The formation of the optical image makes it possible to display the raster pattern of the specified color (herein, the R color) used for adjusting the variable reference voltage Vcom of the common electrode caused by the variation with time ascribable to the liquid crystal display device into the excellent reference voltage (where no flicker is recognized) at the locations of the optical sensors 10 installed on the outer peripheral portion (outside of the effective display area) of the screen 20. In this embodiment, the three-plate liquid crystal display (LCD) device is assumed. However, the LCD device is not limited to the three-plate composition. This embodiment may be applied to the LCD composition of one or more plates.

If the liquid crystal display device has a three-plate composition, the adjustment of flickers is carried out for each of the R, the G and the B panels. Hence, when adjusting the R panel, the raster pattern of the R color is displayed on all the optical sensors 10. Likewise, for the G or the B color panel, the raster pattern of each color is displayed on all the optical sensors 10.

Then, the detection signal of the specified color (herein, the R color) outputted from the optical sensors 10 is inputted into the signal processing circuit 30. As shown in FIG. 7, the signal processing circuit 30 is composed of a high-pass filter 31, a low-pass filter 32 and an A/D converter 33. The detection signals detected by the optical sensors 10 are added into one signal and then is inputted into the signal processing circuit 30. The detection signal inputted into the signal processing circuit 30 is inputted into the high-pass filter 31, in which the DC components are removed from the signal and only the AC components are extracted. The AC components are inputted into the low-pass filter 32, in which the noises contained in the detection signal are removed. The resulting signal is inputted into the A/D converter 33. The A/D converter converts the analog detection signal outputted from the low-pass filter 32 into the digital signal in the predetermined sampling period.

The digital detection signal, which is A/D-converted by the signal processing circuit 30, is inputted into the control circuit 40. The control circuit 40 compares a voltage (digital detection signal voltage) DVₚₚ of the inputted digital detection signal with a digital flicker limit voltage VD_{FL} pre-stored in the memory so that the drive circuit 50 may adjust the variable reference voltage Vcom of the common electrode caused by the variation with time ascribable to the liquid crystal display device 73 into the excellent reference voltage in response to the digital detection signal inputted into the drive circuit 50. If the digital detection signal voltage DVpp is equal to or less than the digital flicker limit voltage DVFL (that is, yes), the flickers are not recognized. It means that the flicker adjustment of the liquid crystal display device corresponding with the first color, that is, the R color is terminated. Then, the operation goes to an S509. If the digital detection signal voltage DVₚₚ is more than the digital flicker limit voltage DV_{FL} (that is, no in the determination of the S502), at first, the new digital reference voltage value changed in the direction of enhancing the current set reference voltage in the digital voltage step SVstep is sent to the drive circuit 50. The drive circuit 50 minutely changes the reference voltage of the common electrode (S503). Then, in an S504, the operation is executed to compare the digital detection signal voltage DVₚₚ(u) after change with the voltage DVₚₚ before change. If the former is smaller, in an S505, the digital detection signal voltage DVₚₚ(u) is compared with the digital flicker limit voltage DV_{FL}. If the digital detection signal voltage DVₚₚ(u) is more than the digital flicker limit voltage DV_{FL}, in an S506, the reference voltage Vcom after change is raised by one step in the digital voltage step SVstep. Then, the operation goes back to the S505, from which the operations of the S505 and S506 are repeated until the digital detection signal voltage DVₚₚ(u) is made equal to or less than the digital flicker limit voltage DV_{FL}. If the digital detection signal voltage DVₚₚ(u) is made equal to or less than the digital flicker limit voltage DV_{FL} in the S505, the new digital reference voltage DVcom corresponding with the reference voltage at the time is set as the current set reference voltage of the liquid crystal display device of the R color and then stored in the memory. Then, the operation goes to the S509.

If it is determined that the new digital detection signal voltage DVₚₚ(u) after change is more than the digital detection signal voltage DVₚₚ before change in the S504, the operation goes to an S507. In the S507, conversely, the current set reference voltage is dropped by one step in the digital voltage step DVstep. Then, in the S508, the new digital detection signal voltage DVₚₚ(d) after change is compared with the digital flicker limit voltage DV_{FL}. If the digital detection signal voltage DVₚₚ(d) is more than the digital flicker limit voltage DV_{FL}, the operation goes back to the S507, from which the operations of the S507 an S508 are repeated until the digital detection signal voltage DVₚₚ(d) is made equal to or less than the digital flicker limit voltage DV_{FL}. If it is determined that the digital detection signal voltage DVₚₚ(d) is equal to or less than the digital flicker limit voltage DV_{FL} in the S508, the new digital reference voltage DVcom corresponding with the reference voltage at that time is set to the current reference voltage of the liquid crystal device of the R color and then is stored in the memory. Then, the operation goes to the S509.

The foregoing process completes the flicker adjustment of the liquid crystal display device corresponding with the first color, that is, the R color.

Then, in the S509, it is determined if the flicker adjustment of the liquid crystal display device corresponding with the second color (herein, the G color) is terminated. If no, the color of the raster pattern is changed into the second color, that is, the G color in the S510, the operation goes back to the S502. In this step, like the case of the R color, the flicker adjustment of the liquid crystal display device of the G color is carried out in the S502 to S508. If yes in the determination of the S509, it means that the flicker adjustment of the liquid crystal display device corresponding with the second color, that is, the G color is terminated. Then, the operation goes to an S511, in which it is determined that the flicker adjustment of the liquid crystal display device corresponding with the third color, that is, the B color is terminated. If no in the S511, the color of the raster pattern in the S512 is changed into the third color, that is, the B color in the S512. Then, the operation goes back to the S502. In the S502, like the cases of the R and the G colors, the flicker adjustment of the liquid crystal display device of the B color is carried out in the S502 to S508. If yes in the determination of the S511, it means that the flicker adjustments of all the colors are terminated, and the flicker adjustment process is completed.

In this embodiment, the optical sensors are located on the outer peripheral portion of the screen, so that the optical sensors may be easily installed thereon. Further, the outer peripheral portion of the screen is unlikely to be influenced by the heat of the heat source (such as a light source). Hence, the sensors installed on the outer peripheral portion of the screen are not required to be highly heat-resistant ones. It means that the relatively inexpensive optical sensors may be used for that purpose.

As described above, this embodiment makes it possible to automatically adjust the variable reference voltage of the common electrode caused by variation with time ascribable to the liquid crystal display device into the excellent reference voltage (that is, the voltage state where no flicker is recognized).

It goes without saying that the liquid crystal display device according to the present invention may be applied to not only the active-matrix liquid crystal display device but also the simple-matrix liquid crystal display device.

Second Embodiment

The first embodiment concerns with a serial adjusting process of serially carrying out the flicker adjustments of the liquid crystal display device corresponding with the first color (for example, the R color), the liquid crystal display device corresponding with the second color (for example, the G color), and finally the liquid crystal display device corresponding with the third color (for example, the B color). However, this serial adjustment process takes a considerably long time in completing all the flicker adjustments. Hence, the below-described second embodiment concerns with the flicker adjustment of each color at a time and in parallel for the purpose of reducing the adjustment time.

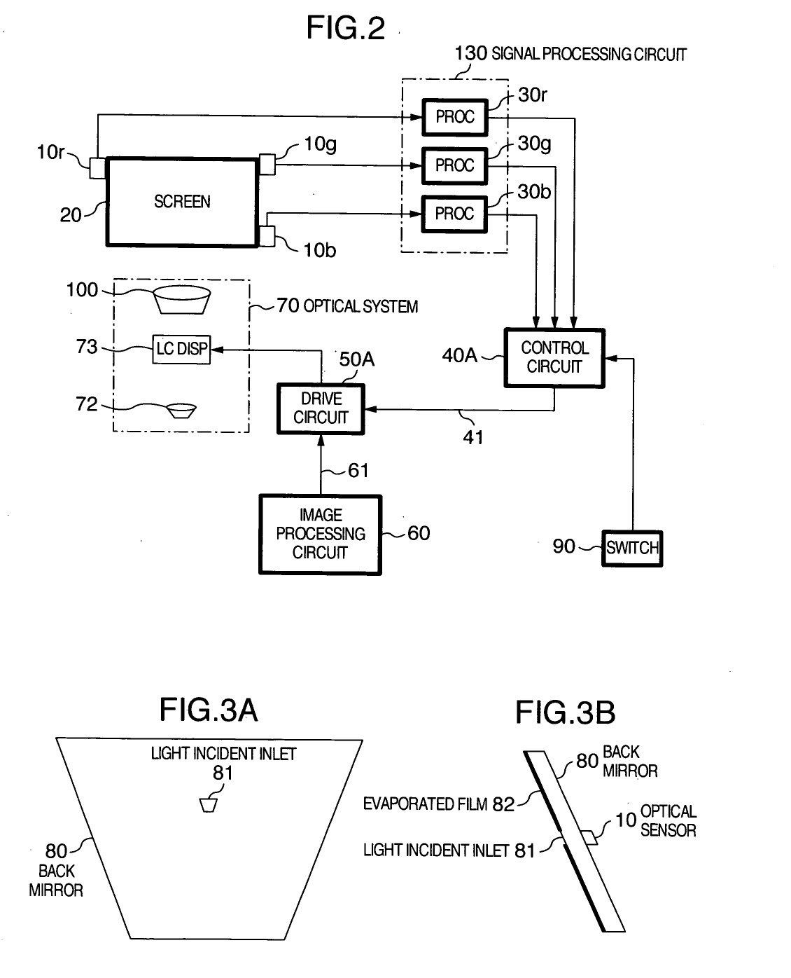

FIG. 2 is a block diagram showing a liquid crystal display device according to the second embodiment of the present invention. In FIG. 2, the components having the same functions as those shown in FIG. 1 have the same reference numbers and are not described for avoiding the duplicated description.

In FIG. 2, On the outer peripheral portion of the screen 20 are located optical sensors 10r, 10g and 10b for detecting the image rays of light corresponding with the raster patterns of different colors (for example, R, G and B), respectively. The detection signals detected by these optical sensors 10r, 10g and 10b are inputted into the signal processing circuit 130.

The signal processing circuit 130 includes three signal processing circuits 30 each of which has been described in FIG. 1. Concretely, the circuit 130 is composed of a signal processing circuit 30r for processing the detection signal sent from the optical sensor 10r, a signal processing circuit 30g for processing the detection signal sent from the optical sensor 10g, and a signal processing circuit 30g for processing the detection signal sent from the optical sensor 10b. Each detection signal, which is sent from each optical sensor 10x (hereafter, “x” denoting any one of r, g and b) and is inputted into each signal processing circuit 30x, is inputted into each high-pass filter 31x. The high-pass filter 31x removes the DC components from the detection signal and extracts only the AC components therefrom. The resulting signal is inputted into each low-pass filter 32x in which noises are removed from the signal. Then, the low-pass filter 32x inputs the noises-removed detection signal into each A/D converter 33x. Each A/D converter 33x digitally converts the detection signal outputted from the low-pass filter 32x into the digital signal in the predetermined sampling period. Each digital signal is inputted into the control circuit 40A.

The drive circuit 50A of this embodiment is different from that of the first embodiment in a respect that the color of the raster pattern that corresponds to the built-in test pattern is made to be the corresponding color with the optical sensor 10x on each color-irradiated concerned area at the location of the optical sensor 10x, concretely, the raster pattern of the red color is irradiated onto the optical sensor 10r, the raster pattern of the green color is irradiated onto the optical sensor 10g, and the raster pattern of the blue color is irradiated onto the optical sensor 10b at a time.

When the switch 90 is handled, like the first embodiment, the control circuit 40A starts the flicker adjustment. In this embodiment, however, the drive circuit 50A is caused to irradiate the raster pattern of each color at the location of each optical sensor 10x. Then, the control circuit 40A is supplied with the digital detection signal from each optical sensor 10x, the detection signal being processed by the signal processing circuit 130, compares each digital detection signal voltage DVₚₚ with the digital flicker limit voltage DV_{FL} of the common electrode of each liquid crystal display device pre-stored in the memory at a time in parallel, and performs the feedback control so that each digital detection signal voltage is made equal to or less than the digital flicker limit voltage DV_{FL}, for the purpose of adjusting the variable reference voltage of the common electrode of each liquid crystal display device caused by the variation with time ascribable to each liquid crystal display device 73 into the excellent reference voltage.

The series of feedback processes of the second embodiment are the same as those of the first embodiment except that these series of processes are carried out at a time in parallel in each color liquid crystal display device. Hence, the description about the details of the feedback process is left out.

As set forth above, in this embodiment, the optical sensor 10x corresponding with each color is located on the outer peripheral portion of the screen 20, the signal processing circuit 130 is provided for processing the detection signal detected by each color sensor 10x at a time in parallel, and the raster pattern of the corresponding different color is irradiated onto each optical sensor 10x. This arrangement makes it possible to perform the feedback control at a batch so that each digital detection signal voltage may be made equal to or less than the digital flicker limit voltage DV_{FL} based on the detection signal detected by each optical sensor 10x. This means that the second embodiment is capable of reducing the adjusting time in comparison with the first embodiment.

Third Embodiment

In the first and the second embodiments, the optical sensors 10 are located on the outer peripheral portion of the screen 20. However, the present invention is not limited to this location. In the first and the second embodiments, since the optical sensors are located on the outer peripheral portion of the screen, the quantity of light received by the optical sensors is small and the output signal amplitude of each optical sensor is also reduced. In the third embodiment, therefore, the optical sensor 10 is located on the rear of the back mirror (back-to-back mirror) used in the back projective type liquid crystal display device. This third embodiment will be described below.

FIGS. 3A and 3B are schematic diagram showing a back mirror that concerns with the third embodiment. FIG. 3A is an imaginary view provided when viewing the back mirror 80 from the front. FIG. 3B is an imaginary view provided when viewing the back mirror from the side.

In this embodiment, the optical sensor 10 is mounted on the rear surface of the back mirror 80 that reflects (back) the light projected from the optical system 70 toward the screen. At the reflective plane (located inside the effective display area) of the surface side corresponding with the location of the optical sensor 10, a light incident inlet 81 that guides light into the optical sensor 10 is provided by removing the portion of an evaporated metallic film 82 corresponding with the inlet 81 from the film 82 that forms the reflective surface of the back mirror 80 as shown in FIG. 3B. In addition, it is better to make the light incident inlet 81 smaller. Preferably, the size of the inlet 81 should be smaller than that of one pixel, because the shadow area on the screen caused by no reflection on the light incident inlet is made so small that the viewer cannot recognize the shadow easily and the luminance can be kept as high as possible. Then, in the process of passing the raster pattern generated by the drive circuit 50 through the optical system 70, reflecting back the raster pattern on the back mirror 80, and projecting it on the screen 20, the optical sensor 10 is served to detect a luminance of the liquid crystal display device.

Further, in this embodiment, the location of the optical sensor on the back of the screen offers the effect that the shadow of the wirings of the optical sensor is not projected on the screen.

In this embodiment, unlike the first and the second ones, the optical sensor is located not on the outer peripheral portion of the screen but on the effective display area of the projective image sent from the liquid crystal display device. Hence, since the quantity of light received by the optical sensor is more than that of the outer peripheral portion of the screen, the output signal amplitude of the optical sensor is made larger, so that the luminance of the projective image can be detected with accuracy and the accuracy of the flicker adjustment can be enhanced as well.

The flicker adjustment of this embodiment is the same as that of the first embodiment. The description about the details of the flicker adjustment is left out. It is obvious that the flicker adjustment having been stated in the second embodiment may be applied by two or more light incident inlets 81, for example, three inlets 81 that detect the R light, the G light and the B light respectively. Hence, the description about the details thereof is also left out.

Fourth Embodiment

In the third embodiment, the optical sensor has been located on the rear of the back mirror placed on the way of a light path leading from the liquid crystal display device to the screen. The location of the optical sensor is not limited to the above location. In the fourth embodiment, the optical sensor is located within the projection lens unit 200. Hereafter, the fourth embodiment will be described with an example of a rear projection television.

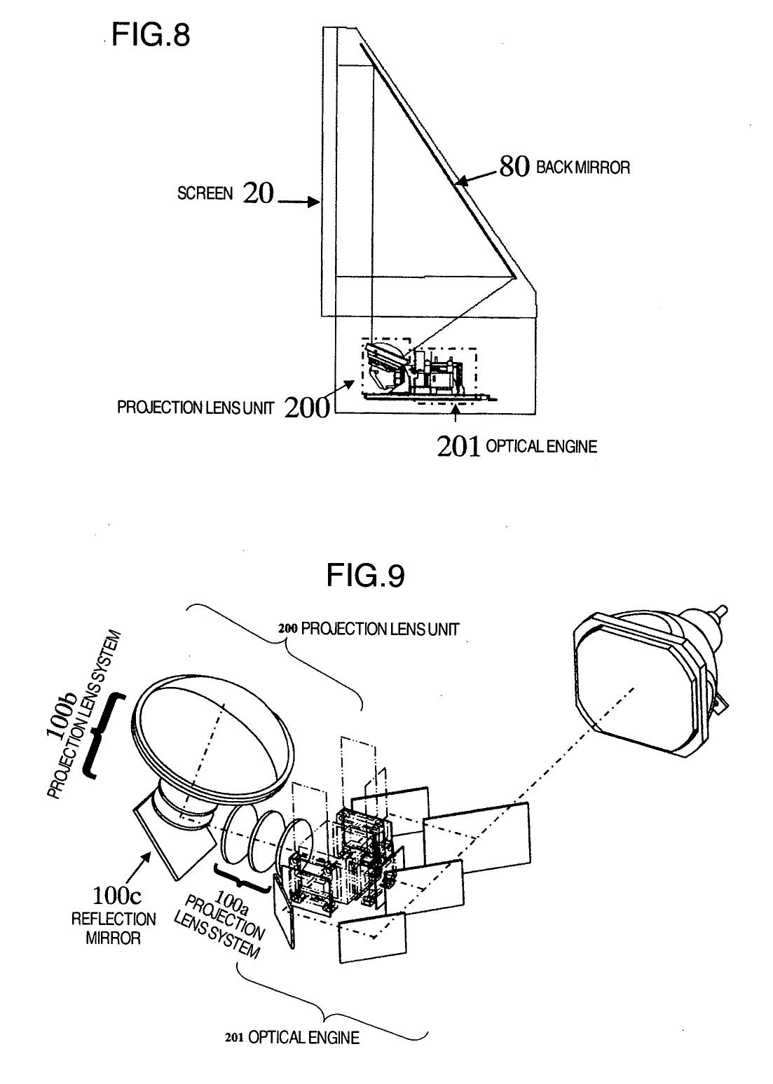

FIG. 8 is a model diagram showing the rear projection television. As shown in FIG. 8, the rear projection television is arranged to form an optical image on the liquid crystal display device located inside an optical engine 201 in response to an input video signal (not shown), irradiate a ray of light from a light source, expansively project the optical image through the projection lens unit, and display the corresponding image with the input video signal on the screen 20 through the back mirror 80.

FIG. 9 is a model diagram showing the projection lens unit and the optical engine which are included in the fourth embodiment. As shown in FIG. 9, in this embodiment, the projection lens unit 200 is composed of a first projection lens system 100a and a second projection lens system 100b. This composition makes it possible to cope with an inch-by-inch difference of a projection distance merely by exchanging the second projection lens system. A reflection mirror 100c is located between two projection lens systems 100a and 100b.

In this fourth embodiment, the optical sensor is located inside the projection lens unit 200. The grounds of this location will be now described. The sensitivity of the optical sensor becomes higher as the quantity of light is made more and the quantity of light is attenuated more as the optical distance of the optical sensor from the light source is made longer. Hence, it is preferable to locate the optical sensor as close to the light source as possible for making the sensitivity of the sensor higher, so that the optical sensor may be located within the projection lens unit closer to the light source than the locations of the optical sensors described in the first to the third embodiments. This location makes it possible to detect flickers at a higher sensitivity.

Further, in the invention of the present application, the image display device is arranged to detect flickers appearing on the liquid crystal display device. Hence, it is possible to locate the optical sensor immediately after the liquid crystal display device placed within the optical engine 201. However, the detection of light before synthesizing the R, the G and the B lights needs three optical sensors dedicated to the R, the G and the B respectively. Moreover, the location of the optical sensor on the light path before synthesizing the lights results in breaking the balance (white balance) of the light quantity of the R, the G and the B, thereby being unable to obtain the necessary light quantity for each color. Hence, by locating the optical sensor within the projection lens 200 placed after synthesizing the R, the G and the B lights, only one optical sensor is needed for detecting flickers and the adjustments of the R, the G and the B light quantities are not newly required. As a result, the detection of flickers is realized with a simple composition.

The locating place of the optical sensor in the projection lens unit should be the place in which the projected image is out of focus. For example, it is preferable to locate the optical sensor on the reflection mirror between the projection lenses, between the projection lenses, on the projection lens, or the like. By installing the optical sensor in the place where the image is out of focus, it is possible to lessen the adverse influence of the shadow appearing on the screen and thereby to lower an uncomfortable feeling a user who watches the screen may feel. Moreover, if the optical sensor is installed in the defocused place, the optical sensor may be located inside the effective display area of the projected image.

In a case that the optical sensor is installed on the reflection mirror 100c, like the third embodiment, the optical sensor (not shown) is located on the rear of the reflection mirror 100c. In this case, a light incident inlet (not shown) for guiding light to the optical sensor is formed on the reflective surface located on the surface side of the reflection mirror 100c. This inlet should be made as small as possible, in particular, reduced to one pixel or smaller. In addition, though the optical sensor is located on the rear of the reflection mirror, it may be located on the front thereof.

In a case that the optical sensor is installed between the projection lenses, no work of installing the optical components and the like is required. For example, the installation is made possible merely by such a light work as screwing the components on the structure parts.

Further, in a case that the optical sensor is installed in the projection lens, it is better to select the defocused place. This selection makes it possible to lessen the adverse influence of the shadow appearing on the screen.

This fourth embodiment has been described with an example of the rear projection television (rear projection type liquid crystal display device). In actual, however, this embodiment is may be applied not only to this type of display device but also to the front projection type liquid crystal display device.

Moreover, this fourth embodiment has been described with an example of the projection lens unit composed of two projection lens systems. In actual, however, this embodiment may be applied not only to this lens composition but also the projection lens unit composed of one or plural projection lens systems.

In this fourth embodiment, the image display device is arranged to use the liquid crystal display device as the display device. In actual, however, the display device is not limited to the liquid crystal display device.

In this fourth embodiment, like the third embodiment, the flicker adjustment is the same as that of the first embodiment. Hence, the details thereabout are not described herein. Further, it is obvious that the flicker adjustment having been described with respect to the second embodiment may be applied to the fourth embodiment by providing plural, for example, three light incident inlets 81 for detecting the R light, the G light and the B light respectively. Hence, the details thereabout are not described herein.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. An image display device arranged to irradiate a ray of light from a light source onto display devices, form an optical image corresponding with a video signal, and expansively project said optical image, comprising:
a reflection mirror which reflects said ray of light irradiated onto said display devices;
an optical sensor which detects a light intensity after irradiating said ray of light onto said display devices;
a drive circuit which causes said display devices to be driven; and
a control circuit which controls said drive circuit based on said light intensity detected by said optical sensor; and
said optical sensor being located on said reflection mirror.

2. An image display device as claimed in claim 1, further comprising a plurality of lenses which expansively project said optical image; and
said back mirror being located on an optical path leading among said plurality of lenses.

3. An image display device as claimed in claim 1, further comprising a display unit which forms an image of said light reflected on said reflection mirror; and
said reflection mirror being located on the rear of an image display surface of said display unit.

4. An image display device as claimed in claim 1, wherein said display device is a liquid crystal display device.

5. An image display device as claimed in claim 2, wherein said optical sensor is located on the rear of a reflective surface of said reflection mirror.

6. An image display device as claimed in claim 3, wherein said optical sensor is located on the rear of a reflective surface of said reflection mirror.

7. An image display device as claimed in claim 2, wherein said reflection mirror provides an incident inlet into which said ray of light enters and said optical sensor detects an intensity of light passing through said incident inlet.

8. An image display device as claimed in claim 3, wherein said reflection mirror provides an incident inlet into which said ray of light enters and said optical sensor detects an intensity of light passing through said incident inlet.

9. An image display device as claimed in claim 7, wherein the size of said incident inlet is equal to or smaller than that of one pixel.

10. An image display device as claimed in claim 8, wherein the size of said incident inlet is equal to or smaller than that of one pixel.

11. An image display device arranged to irradiate a ray of light from a light source to display devices, form an optical image corresponding with a video signal, and expansively project said optical image, comprising:
a screen which forms an image of said expansively projected ray of light and displays said image corresponding with said video signal;
an optical sensor which detects an intensity of said light irradiated onto said display devices;
a drive circuit which causes said display devices to be driven; and
a control circuit which controls said drive circuit based on said intensity of light detected by said optical sensor; and
said optical sensor being located on an outer peripheral portion of said screen.

12. An image display device as claimed in claim 11, wherein the outer peripheral portion of a display unit indicates an outside of an effective display area in said display unit.

13. An image display device as claimed in claim 12, wherein a plurality of optical sensors are provided on the outer peripheral portion of said display unit.

14. An image display device comprising:
a light source;
a display device to which a ray of light is irradiated from said light source and which forms an optical image corresponding with a video signal;
a projection lens unit which expansively projects said optical image;
an optical sensor which detects an intensity of said light irradiated onto said display device;
a drive circuit which causes said display devices to be driven; and
a control circuit which controls said drive circuit based on the light intensity detected by said optical sensor; and
said optical sensor being located within said projection lens unit.

15. An image display device as claimed in claim 14, further comprising:
a reflection mirror being located within said projection lens unit and which reflects said ray of light reflected onto said display devices; and
said optical sensor being located on said reflection mirror.

16. An image display device as claimed in claim 14, wherein said projection lens is composed of a plurality of projection lenses and said optical sensor is located between said plurality of projection lenses.

17. An image display device as claimed in claim 14, wherein said optical sensor is installed on said projection lens located within said projection lens unit.
